(19) United States
(12) Patent Application Publication
(10) Pub. No.: US 2013/0246139 A1
(43) Pub. Date: Sep. 19, 2013

(54) SYSTEM AND METHOD FOR SHARING INCENTIVES AMONG GROUPS

(71) Applicants: Douglas P.C. Hardman, Shaker Heights, OH (US); Douglas Martin Pierce, Perry, OH (US); Zak MacDonald, Portland, OR (US)

(72) Inventors: Douglas P.C. Hardman, Shaker Heights, OH (US); Douglas Martin Pierce, Perry, OH (US); Zak MacDonald, Portland, OR (US)

(73) Assignee: Sparkbase LLC, Cleveland, OH (US)

(21) Appl. No.: 13/734,487

(22) Filed: Jan. 4, 2013

Related U.S. Application Data
(60) Provisional application No. 61/583,106, filed on Jan. 4, 2012.

(51) Int. Cl. G06Q 50/00

(52) U.S. Cl. CPC G06Q 50/01; G06Q 30/0207
USPC 705/14.16; 705/14.66; 705/14.58; 705/14.53

(57) ABSTRACT

A system and method for sharing incentives, restricted price reductions, and stored value quantities among groups of persons, more particularly to support sharing transactions between members in a group. The system and method for sharing incentives includes receiving item information for at least one item associated with a friend, displaying the item information in a prioritized location viewable by at least one authorized friend, and receiving a request from the authorized friend to take the item, and removing from view the item information associated with the item.

This application claims the benefit of U.S. Provisional Application 61/583,106, filed Jan. 4, 2012. The patent application identified above is incorporated here by reference in its entirety to provide continuity of disclosure.

### BACKGROUND OF THE INVENTION

The present systems and methods relate generally to the provision of sharing incentives, restricted price reductions, and stored value quantities among groups of persons, more particularly to support sharing transactions between members in a group. It is relatively common for persons to clip and share physical coupons with friends and associates. Recently this behavior has been modified to include emailing coupons or sharing links or codes to discounts to friends and associates. Many merchant programs involving coupon or promotion offers (referred to generally herein as incentives) worked adequately well with this informal sharing mechanism. However for merchants or offerors tracking and targeting incentives to specific persons is problematic. In one manner, tracking of a specific incentive provided to an individual could be accomplished by assigning a unique serial identifier or other unique identifier such as a bar code or label to tag and associate to a particular distribution method or a particular user. Recently merchants have been leveraging existing social networks' users to follow electronically when a customer would notify friends of incentives by sharing, “like”, or “+1” an incentive, which acts as a broadcast message to other members of their social graph who happen to login to the site or check their notifications in a timely manner.

On the user side sharing incentives typically occurs coincidentally or in a relatively ad hoc manner. Only when a user is online within such time of a friend's sharing, and as long as such sharing has raised to the appropriate level of relevance within the system, are users made aware of incentives that a friend has shared. Similarly, in the offline context, sharing of incentives only occurs when friends are meeting for some other reason and the topic of the incentive raises to a level of relevance in the conversation higher than other topics discussed within the meeting time. Currently users have no method of having all shared incentives in one location that is easily accessible. If there were enough shared incentives in one location and they could more easily be organized, users would be more likely to look for a shared incentive before making a purchase at full price.

On the offeror side feedback regarding promotions can be limited and inefficient. Offerors would like to know the channels of distribution that their incentives took. Using such information, offerors can better create incentives that more effectively reward specific demographics by knowing who shared an incentive with whom.

Accordingly, creating a system and method that allows for easy searching, sharing and classification of shared incentives would be highly useful to users and offerors.

### BRIEF DESCRIPTION OF DRAWINGS

The claimed subject matter is described with reference to the accompanying drawings. The accompanying drawings depict multiple embodiments of the claimed system and method. A brief description of each figure is provided below. Elements with the same reference number in each figure indicate identical or functionally similar elements. Additionally, the left-most digit(s) of a reference number indicate the drawing in which the reference number first appears.

FIG. 1 is a diagram of an exemplary basic system showing the functionality of the social wallet system allowing sharing incentives across multiple social graphs.

FIG. 2 is an exemplary flowchart of an embodiment of a transaction process for a social wallet system.

FIG. 3 is an exemplary flowchart depicting an embodiment transaction process of the intended use feature of a social wallet system.

FIG. 4 is a block diagram of an embodiment of a system for describing the activities of a user in a social wallet system.

FIG. 5 is a block diagram of an embodiment of a system, available to an offeror, for choosing the characteristics of those users they make offers to.

FIG. 6 is a block diagram of an embodiment of a system, available to an offeror, for choosing the details of the offers made to users.

FIG. 7 is a diagram of a general purpose computer system suitable for operating the present system and method.

FIG. 8 is a diagram of an exemplary environment for operating the present system and method.

FIG. 9 is an exemplary depiction of directed social graphs with relation to a set of users.

FIG. 10 is an exemplary depiction of directed social graphs with relation to a set of users.

### DETAILED DESCRIPTION

Systems and methods described herein support provision and management of sharing incentives among groups. As used herein, a shared incentive is a coupon, offer, reward or other incentive for use at various stores or locations, both online and physical, capable of being shared among a social graph. As used herein, a social graph is a mapping of persons and how they are related to each other, in other words, it is a manner of representing persons who exist and how they relate to one another based on a person's social network.

Merchants or offerors employ incentives, in part, as a way to reward customer loyalty and encourage customers to purchase items or consume services for which those customers would otherwise not purchase. The present system and method provide a mechanism for a merchant to tailor incentive programs to achieve specific goals. In one aspect, the incentive program is tailored to provide incentives to promote loyalty or return shopping from frequent customers. In another aspect, the merchant uses the incentive program for driving new potential customers to a store by exploiting existing customers or potential customers who were identified with more conventional means who in turn recruit their social network to take advantage of a particular discount. In this manner, a merchant can draw more potential new customers who may not have otherwise been identified but for the social networks of their existing customer base.

The amounts and time periods for which the incentives are good can be fine-tuned for those specific goals that individual offerors might have. For example, a men's fragrance offeror might have an incentive that offers a buy one get one deal. Previously, a spike during Valentine's day might appear nebulous, however if it were tracked that groups of linked females had used the incentives one might more accurately be able to suggest that this product has been approved of by a woman and that her approval was a strong factor in her female friends making similar purchases for their beaus. Such information could greatly increase the accuracy of marketing. Such information could also suggest that the incentive should expire after Valentine's day because after that time the only users of the incentive are those who might regularly purchase the product at full price.

As used herein, an offeror is an entity who may not directly vend a particular item or service, but rather performs marketing and targeted advertisement on behalf of one or more entities to encourage consumption of goods or services from particular merchants. In one aspect an offeror is a national chain or franchiser who provides offers that are usable at multiple merchants (franchisees). As used herein, when reference is made to a merchant, an offeror is also implied unless stated otherwise or when reference is made to provision of goods or services. Conversely, when reference is made to an offeror, a merchant is also implied unless stated otherwise or when reference is made to a separate marketing entity who does not provide goods or services directly or indirectly.

Also, in certain exemplary embodiments, when reference is made to a ‘product’ the reference includes both products and services, including services such as tickets for events as well as personal services such as cleaning, transportation, consulting or advisory services and the like.

As used herein, the term “item” will refer to any incentive, coupon, rebate, reward, stored value, gift card or other mechanism for offering an incentive to a customer or prospective customer that can be shared and redeemed for some value towards goods or services. As used herein, the term “promotion” will refer to a series of items that are the same or linked in some fashion, often with a unifying vision underlying their construction.

As used herein, the term “item information” will refer to information pertaining an item, such as the amount of an incentive, limits on the incentive, such as temporal restrictions, qualified purchases, or number of friends an inventive can be shared with.

The present system and method in another aspect allows for detailed tracking of shared incentives to enable offerors to more closely tailor and adjust incentive programs. The goal of any incentive program is to provide more efficient pricing—to encourage the greater consumption of goods or services from a particular merchant. An incentive program is judged at least in part based on its ability to encourage the purchase of specific goods or services at the most optimal price. A broad coupon program may not achieve this, since in some circumstances it provides a mechanism that enables a customer to purchase a product at a reduced price when that particular customer would have otherwise purchased the product at full price. The present system and method enables merchants to more closely track consumption of specific incentives thereby enabling greater tailoring of incentives to more optimally price the merchant's products. This enables offerors to provide better targeted incentives and potentially even greater rewards to customers by eliminating revenue lost to those people using incentives who would have bought the product at full price regardless of the incentive.

The present system and method in yet another aspect allows for detailed tracking of the shared incentives that would create a greater incentive for offerors to give more targeted incentives. These more targeted incentives can better reward their users by having higher dollar amounts, and they can better reward their offerors by focusing on the demographics who are not buying at full price. The offerors can afford to provide higher dollar amount incentives because of the elimination of money lost to those people using incentives who would buy at full price. Such a system is the most efficient form of price discrimination for which all coupon systems are modeled after.

The present system and method allows for users within a social graph to share offers, rewards and coupons with people in their social graph. Each user is presented with a set of shared incentives that is tailored to that user's own characteristics. For example, two users who have overlapping social graphs (i.e. they are both members of each other's social networks) are unlikely to have exactly overlapping social graphs—meaning that each user is likely to have a slightly different set of ‘friends’ in their social graphs unique to that user. In one aspect the social wallet presents incentives that are based on the contributions of the other users in the social graph. Thus is it likely that users with non-overlapping social networks would not receive or be able to access the same shared incentives.

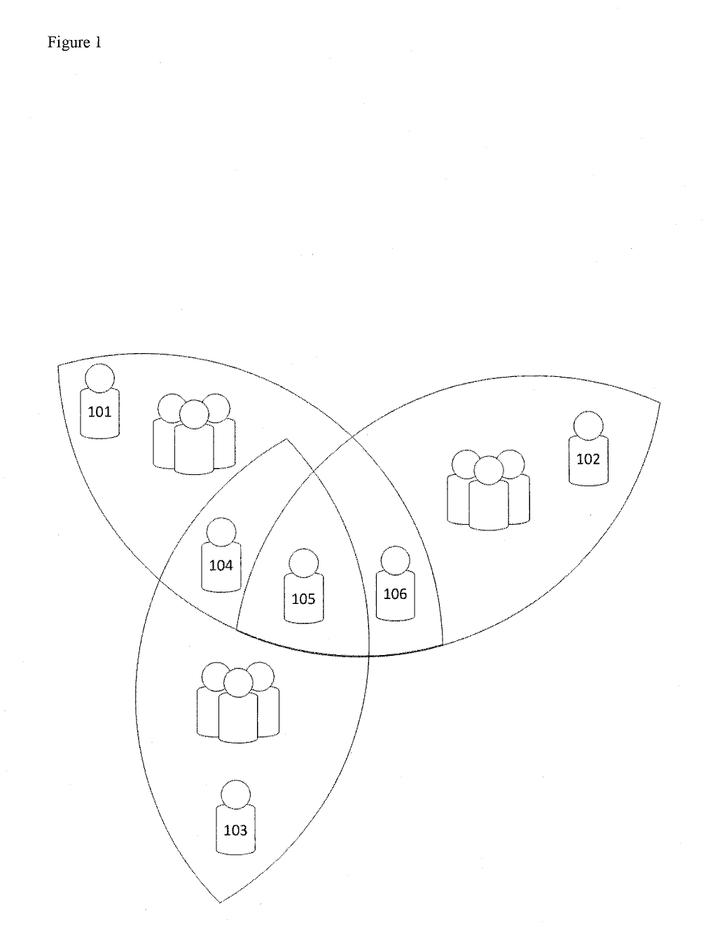

Referring to FIG. 1, a schematic representation of three persons' (101, 102, and 103) social graphs (111, 112, and 113 respectively) is shown. Each person has members who are unique to their specific social graphs that are not directly known to another user, while there are some members who are known to all three users. For example, social graph member 105 is shared between all three persons 101, 102 and 103, while member 106 is only shared between persons 101 and 102. Continuing from the prior paragraph, in one aspect the invention allows unique members 121 who are present in social graph 111 but who are not members of social graphs 112 and 113 to not receive or be aware of incentives available to shared members 104, 105 or 106. In another exemplary aspect, activities of the person 101 or tailoring of the incentive program by the offeror enable certain shared incentives contributed by person 102 to be shared with unique members 121 who otherwise are not directly within the social graph 112 of person 102.

In this manner, the present system and method allows each person (i.e. customer or user as used herein) to have a different set of shared incentives visible to them, as their social graph or friends are different. In one aspect, a user is able to control sharing within more than one degree of their social graph, so in the example of two degrees of sharing, their friends and the friends of their friends may both have access to the incentives that have been shared. In a preferred embodiment a user may choose, by means of preference settings or other settings control, to view offers from what is often designated “friends of friends”, or users within two degrees of their social graph. The user sharing an offer may configure their sharing preference to share just with friends or with friends of friends. In an embodiment, the user sharing the offer may choose to share just with friends or with friends of friends at the time of sharing. In an embodiment, users may choose to view and share with varying degrees of their social graph in an explicit selection of levels.

As used herein, a social wallet is that set of shared items available to a particular user based on the items shared by themselves and the other users in their social graph, and the degrees of sharing associated with each item. In a preferred embodiment a user shares an offer via their social wallet or contributes an item to the social wallet. The items in their social wallet are then viewable by people within their social graph in their own social wallets, though by default, the coupon would be shared and viewable within the first level of connections, but could be user controlled or offeror configured to be shared and viewable within other levels of their social graph. In the preferred embodiment, a merchant would define an offer as sharable with friends or sharable with friends of friends. In this manner, the offer may, dependent upon the sharing and viewing users' preferences, be seen by friends of the sharing user or friends of friends. In one aspect, a user within the sharing user's social graph then sees the offer appear in their social wallet and may take a single use coupon for redemption or may take a multi-use coupon. In an embodiment, users taking an offer from the wallet must share their offers to continue taking limited use coupons shared by other users. As used herein, the term “a user friend” will refer to those users that are within the social graph of specific first user.

As appreciated by one of skill in the art, the present system and method in certain aspects is embodied as a method, data processing system and/or computer program product. Accordingly, the present invention may take the form of an entirely hardware embodiment with logic embedded in circuitry, an entirely software embodiment with logic operating on a general purpose computer to perform, or an embodiment combining software and hardware aspects. Furthermore the system and method in some aspects takes the form of a computer program product on a computer-readable storage medium having computer readable program code means embodied in the medium. Any suitable computer readable medium may be utilized including hard disks, CD-ROMs, optical storage devices, static or nonvolatile memory circuitry, or magnetic storage devices and the like.

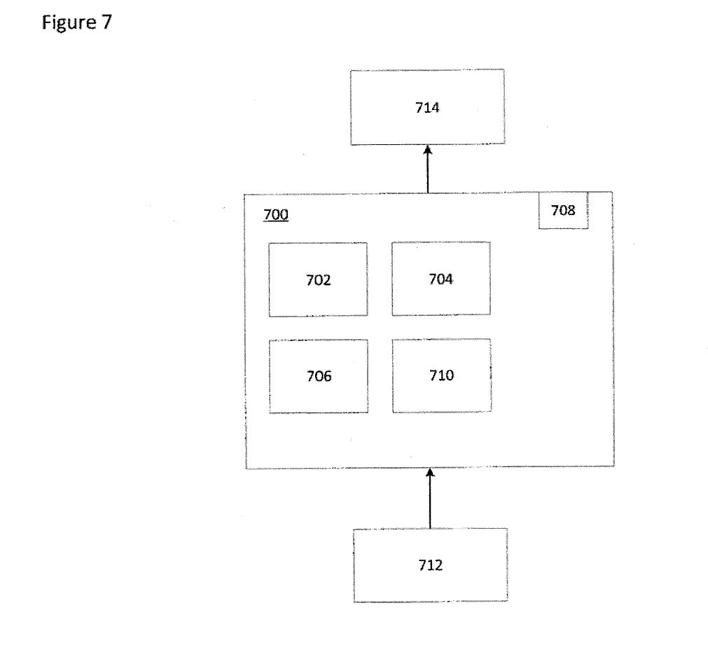

FIG. 7 depicts an exemplary computer system 700, which can be used in implementation of the system and method. The computer system can be a laptop, desktop, server, handheld device (e.g., personal digital assistant (PDA), smartphone), programmable consumer electronics or programmable industrial electronics.

As illustrated the computer system includes a processor 702, which can be any various available microprocessors. For example, the processor can be implemented as dual microprocessors, multi-core and other multiprocessor architectures. The computer system includes memory 704, which can include volatile memory, nonvolatile memory or both. Nonvolatile memory can include read only memory (ROM) for storage of basic routines for transfer of information, such as during boot or start-up of the computer. Volatile memory can include random access memory (RAM). The computer system can include storage media 706, including, but not limited to magnetic or optical disk drives, flash memory, and memory sticks.

The computer system incorporates one or more interfaces, including ports 708 (e.g., serial, parallel, PCMCIA, USB, FireWire) or interface cards 710 (e.g., sound, video, network, etc.) or the like. In embodiments, an interface supports wired or wireless communications. Input is received from any number of input devices 712 (e.g., keyboard, mouse, joystick, microphone, trackball, stylus, touch screen, scanner, camera, satellite dish, another computer system and the like). The computer system outputs data through an output device 714, such as a display (e.g. CRT, LCD, plasma . . . ), speakers, printer, another computer or any other suitable output device.

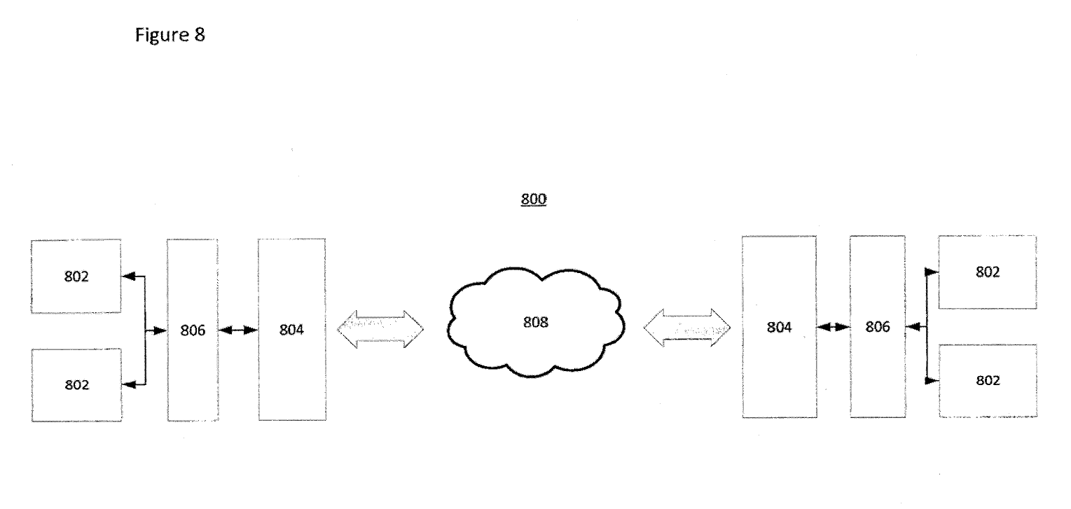

FIG. 8 depicts an exemplary computing environment 800 for implementing the system and method. The computing environment 800 includes one or more clients 802, where a client may be hardware (e.g., personal computer, laptop, handheld device or other computing devices) or software (e.g., processes, or threads). The computing environment 800 also includes one or more servers 804, where a server is software (e.g., thread or process) or hardware (e.g., computing devices), that provides a specific kind of service to a client. The computing environment 800 can support either a two-tier client server model as well as the multi-tier model (e.g., client, middle tier server, data server and other models). In embodiments, the protocol system is a client or hosted by a client device, and the central system is a server, or is hosted on a server.

The computing environment 800 also includes a communication framework 806 that enables communications between clients 802 and servers 804. In an embodiment, clients 802 correspond to local area network devices and servers are incorporated in a cloud 808 computing system. The cloud 808 is comprised of a collection of network accessible hardware and/or software resources. The environment can include client data stores that maintain local data and server data stores that store information local to the servers, such as the module library.

The present invention is described below with reference to flowchart illustrations of methods, apparatus (systems) and computer program products. It will be understood that each block of the flowchart illustrations, and combinations of blocks in the flowchart illustrations, can be implemented by computer program instructions. These computer program instructions may be loaded onto a computer or other programmable data processing apparatus or otherwise encoded into a logic device to produce a machine, such that the instructions which execute on the computer or other programmable data processing apparatus create means for implementing the functions specified in the flowchart block or blocks. These computer program instructions may also be stored in a computer readable memory that can direct a computer or other programmable data processing apparatus to function in a particular manner, such that the instructions stored in the computer readable memory produce an article of manufacture including instruction means which implement the function specified in the flowchart block or blocks. The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

As appreciated by those of ordinary skill in the art, specific functional blocks presented in relation to the present system and method are programmable as separate modules or functional blocks of code. These modules are capable of being stored in a one or multiple computer storage media in a distributed manner. In another aspect, these modules are executed to perform in whole or in part the present system and method on a single computer, in another aspect multiple computers are used to cooperatively execute the modules, and in yet another exemplary aspect the programs are executed in a virtual environment, where physical hardware operates an abstract layer upon which the present system and method is executed in whole or in part across one or more physical hardware platforms.

FIG. 1 is a diagram exemplary basic system showing the functionality of the social wallet system allowing for the sharing of incentives across multiple social graphs. As used herein, the term “exemplary” indicates a sample or example. It is not indicative of preference over other aspects or embodiments. The diagram above breaks down users into three primary groups and shows the wallet functionality based on three users in overlapping groups. In this example, there are three social graphs, labeled 111, 112 and 113 associated with users 101, 102 and 103. There are three example users, labeled 104, 105, and 106. In the case of user 104, that user exists in social graph 111 and social graph 113, so the incentives seen by user 104 in his own social wallet are from the social wallets of users 101 and 103. In the case of user 105, which exists in social graphs 111, 112 and 113, the user sees in his own social wallet incentives from all three users' 101, 102, and 103 social wallets. User 106, exists in social graph 111 and social graph 112, but not social graph 113, so that the incentives seen by user 106 in his social wallet are incentives shared by users 101 and 102 in their social wallets. This example shows social wallet function for one degree of separation within a social graph. An incentive shared with two degrees of social graph separation by user 101 would appear in the social wallet of user 102 because user 102 is friends with both users 104 and 105, which are friends of user 101, which makes user 102 a friend of a friend of user 101. Accordingly, in such a two degrees of social graph separation sharing, those incentives shared by user 102 in their social wallet would also be viewable by user 101 in their own social wallet because of their mutual status as friends of a friend.

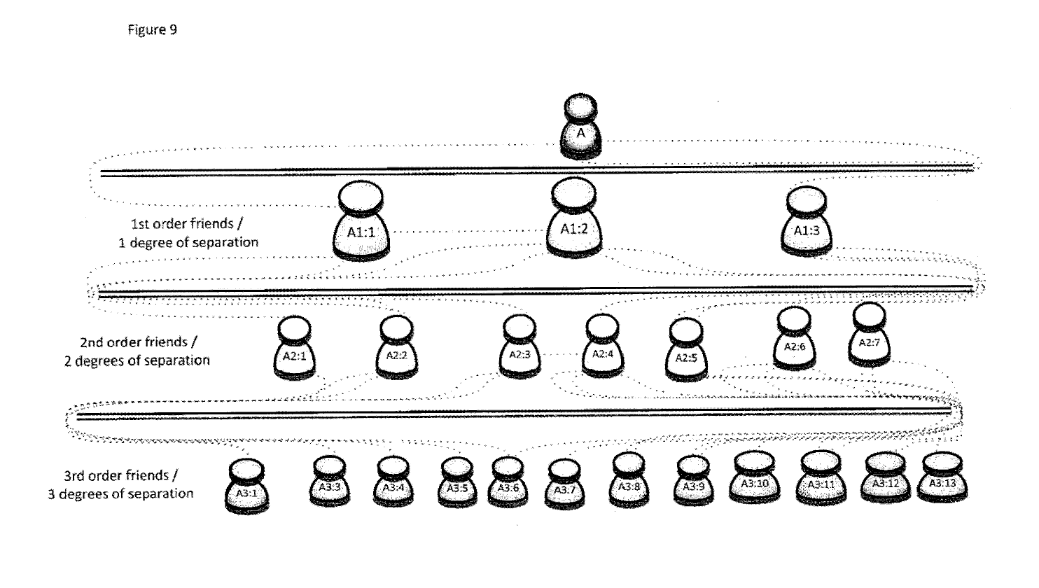

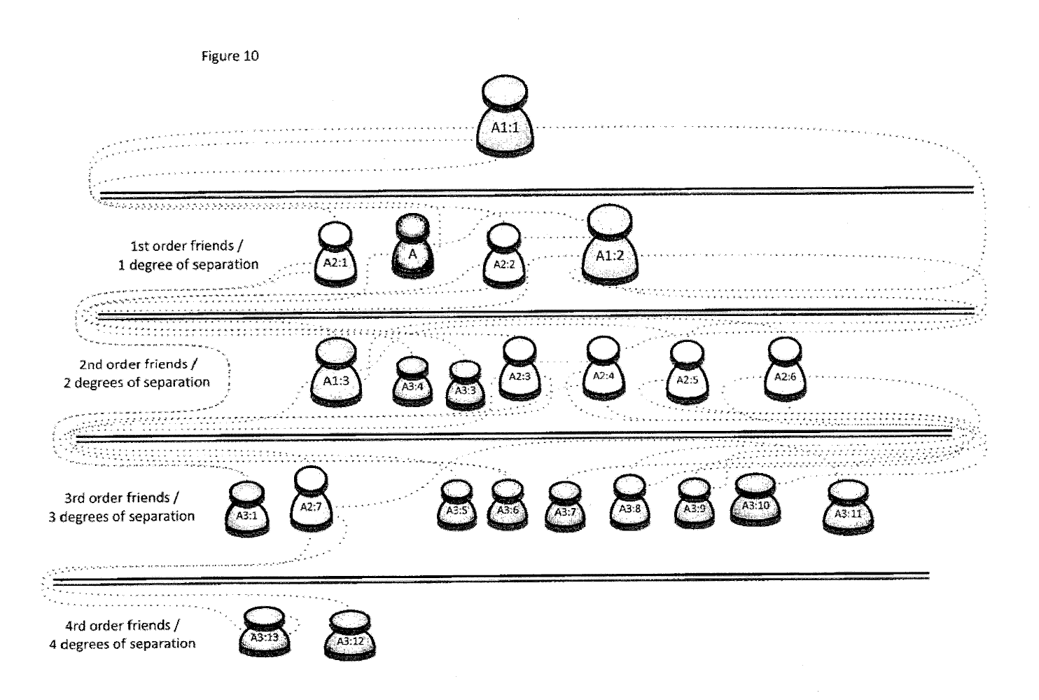

FIGS. 9 and 10 are exemplary depictions of directed social graphs with relation to a set of users. In FIG. 9, a wallet user A's social graph is broken out by level and a dotted line connects each user to their first order of friends (or 1^{st} degree of separation.) Each user is shown with a label that indicates the level within user A's social graph followed by a colon (:) then a unique number for the user within that level. So, the first degree of separation users are labeled A1. Users A1:1, A1:2 and A1:3 exist in the first level of user A's social graph. In FIG. 10, the same users are shown with FIG. 9's user labels, but they are shown with user A1:1 being at the top of the directed graph. Each degree of separation in FIGS. 9 and 10 is separated between two solid lines and each degree is labeled in relation to the user at the top of the diagram. These two diagrams allow for the illustration of social graph membership based on degrees of separation. In one aspect, FIGS. 9 and 10 illustrate two different and unique social graphs. In the preferred embodiment, a social graph comprises the friends of the top level user (or users with one degree of separation). In an embodiment, a social graph may be based on two degrees of separation (friends of friends) from the top user. In an alternate embodiment, the number of degrees of separation in the social graph may be configurable, such that users in social graphs with degrees of separation beyond two may view or share offers with each other from each of their social wallets.

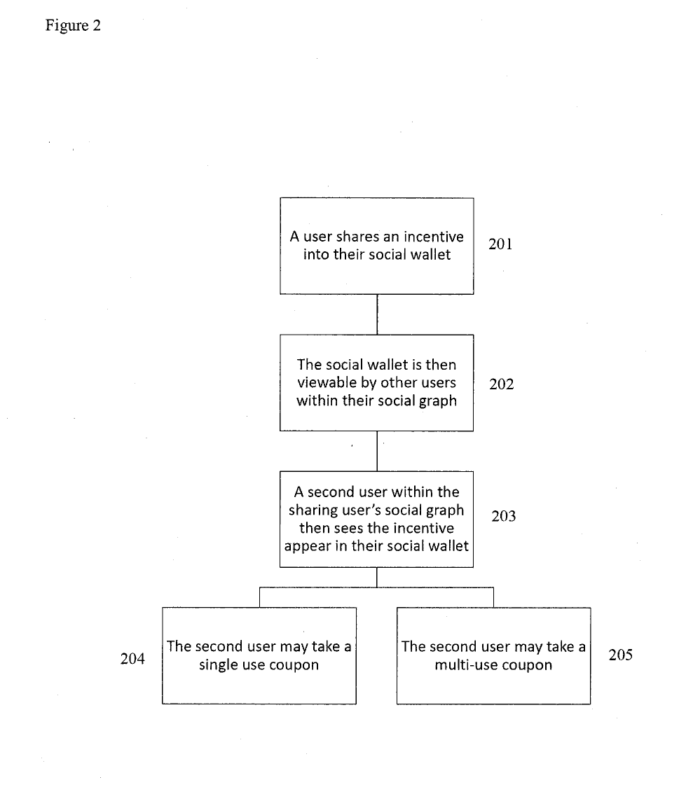

FIG. 2 is an exemplary flowchart of a transaction process 200 for an exemplary aspect of the social wallet system and method. In an embodiment, a user shares an incentive into their social wallet 201. The social wallet is then viewable by people within their social graph 202, though by default, the coupon would be shared with the first level of connections, but could be user controlled or offeror configured to share with other levels of their social graph. A user within the sharing user's social graph then sees the incentive appear in their own social wallet 203 and may take a single use coupon 204 for redemption or may take a multi-use coupon 205. In an embodiment, users taking an incentive from the wallet must share their incentives to continue taking limited use coupons from the wallet.

In one aspect the number of coupons that a user has access to is adjusted based on the used other items that the user has placed in his social wallet that were actually redeemed by others in the social network. In a preferred embodiment, the showing of offers in a social wallet may be prioritized or displayed in preferred manner, where the prioritized showing of an offer may be based on analysis of a specific social wallet's past preferences and behaviors.

In an embodiment, the showing of offers in to a user friend's social wallet may be prioritized or displayed in a preferred manner, where the prioritized showing of an offer may be based on analysis of a specific user friend's past preferences and behaviors. In both of these embodiments of prioritizing an offer's display, the preferences of the users in a specific social graph may be calculated through a number of methods of statistical and mathematical analysis known to those of ordinary skill in the art.

In further embodiments, an offer's display priority may be expressed through a number of forms of visual emphasis. Such forms of visual emphasis to distinguish higher priority offers from lower priority offers include, but are not limited to: placement in a vertical list closer to the higher side, placement in a horizontal list closer to the left side, changes in font type (relative to lower priority offers), changes in font size, changes in font color, changes in background color, change in focus of the offers (whereby a higher prioritized offer is clearer relative to other lower prioritized offers which are relatively blurred), through an animated pop-up whereby a higher prioritized offer pops out of the list while the rest stay in place, outlining a higher prioritized offer, and placement of an icon next to a higher prioritized offer.

As appreciated by those of ordinary skill in the art, analysis algorithms are described along with standard statistical functions that are implementable through computer code or statistical analysis software. In an embodiment, these methods are used to establish correlations between users or social graphs and their past preferences for offers and merchants. Specific preferences may be established through offer redemption, offer viewing, merchant visits, sharing of an offer, liking of a merchant and liking of an offer and the physical proximity of a social wallet user to a merchant. In an embodiment, existing transaction data and loyalty history from merchant Point of Sale Systems, data from electronic wallet usage, mobile application usage and web viewing from computers, mobile phones and other devices can be incorporated in user preference calculations. In the preferred embodiment, similarities between users and their likely offer response preferences may be calculated using a number of standard statistical methods to establish coefficients by which to establish correlation. The most commonly used standard statistical methods for establishing similarity include, but are not limited to: Pearson product-moment correlation coefficient (Pearson Correlation or Pearson Correlation Coefficient), Spearman's rank correlation coefficient or Spearman correlation, the Jaccard index or Jaccard similarity coefficient, the related Tanimoto Similarity or Tanimoto Distance, a Log-likelihood test, Euclidean Distance and collaborative filtering algorithms, including Slope One algorithms for collaborative filtering. The factors used in these correlations may be weighted by one or more factors including, but not limited to: recency, frequency, the type of interest (like, view, save, print) or response to previous offers, the physical proximity of a wallet user to a merchant, the type of merchant and previous responses to similar or correlated merchants and the correlation coefficent values of the social wallet itself.

As appreciated by those of ordinary skill in the art, the analysis of social wallets, user friends and likely preferred offers can be made using a set of analysis algorithms In the preferred embodiment, those of ordinary skill in the art, will analyze the results of the algorithms, testing their results and then changing weighting and analysis input factors to achieve greater statistical significance of the results. In the preferred embodiment, for the classification of social wallet users into statistical neighborhoods, the following algorithm, with varying weights for similarity factors, derives groups of users in to statistical neighborhoods: Starting with a social wallet user u, for every other social wallet user w, compute a similarity s between u and w based on weighting for statistical significance available data on previously shown interest in offers o, merchants visited or interested in m, physical proximity of the user u to a merchant m as p, social network “likes” l, demographic information d and offers redeemed r, based on similarity s classify the most similar social wallet users, ranked by similarity, as a neighborhood n.

In another aspect, social wallets may be classified into statistical neighborhoods, using methods similar to the analysis of individual users into neighborhoods. In an embodiment, the algorithm for classification of social wallets into statistical neighborhoods is as follows: Starting with a social wallet w, for every other social wallet v, compute a similarity s between v and w based on weighting for statistical significance available data on previously shown interest in offers o, merchants visited or interested in m, social network “likes” l by members of the social wallets, demographic information d and offers redeemed r based on similarity s classify the most similar social wallets, ranked by similarity, as a neighborhood n. In an embodiment, clusters of geographic proximity of users within the wallets, may be used to in computing neighborhoods or alternate neighborhoods of social wallets.

In another aspect, the likely preference of a user for a specific offer is calculated by those of ordinary skill in the art of statistical analysis with the following algorithm: Starting with a social wallet user u, for every other user w, compute a similarity s between u and w based on weighting for statistical significance available data on previously shown interest in offers o, merchants visited or interested in m, physical proximity of the user u and the user w to a merchant m as p, social network “likes” l, demographic information d and offers redeemed r, retain the top users, ranked by similarity, as a neighborhood n. Then, for every offer o that some social wallet user in n has a preference for, but that w has no preference for yet, for every other social wallet user v in n that has a preference for o compute a similarity s between u and v, optionally including geographical proximity to merchants offering o as x, using v's preference for o, weighted by s, include v's weighted preference into a running average.

In a preferred embodiment, the likely preference of a wallet user for a merchant may be calculated using the known preferences of statistically similar users. For those of ordinary skill in the art, the likely preference of a user for a merchant is calculated using the following algorithm: For a specific social wallet user u, for every other social wallet user w, compute a similarity s between u and w based on, weighting for statistical significance previously shown interest in offers o, merchants m, likes l, demographic information d, physical proximity to merchant m as x and offers previously redeemed r, retain the top users, ranked by similarity, as a neighborhood n. Then for every merchant m that some social wallet user in n has a preference for, but that u has no preference for yet, for every other social wallet user v in n that has a preference for m, compute a similarity s between u and v, using v's preference for m, weighted by s, include v's weighted preference into a running average. In the preferred embodiment, the running average of the weighted preference then indicates a social wallet user's likely preference for a specific merchant. In this embodiment, offers from merchants that a user is more likely to respond to are prioritized in their display or placement.

In another embodiment, the preference for a specific merchant may be calculated for a specific social graph by someone with ordinary skill in the art using the following algorithm. For a specific social wallet w, for every other social graph v, compute a similarity s between w and v based on, weighting for statistical significance, previously shown interest in offers o, previously shopped merchants m, likes l, physical proximity of wallet users to merchant m as p, demographic information d and offers redeemed r, retain the top social graphs, ranked by similarity, as a neighborhood n. Then for every merchant m that some social graph in n has a preference for, but that w has no preference for yet, for every other social graph x in n that has a preference for m, compute a similarity s between w and x, using x's preference for m, weighted by s, include x's weighted preference into a running average. The calculated running average indicates a specific social graph's likely preference for a merchant and that preference may be used in the prioritization of offer display within that graph or graphs that are statistically similar.

In another embodiment, the likely preference of a social graph for an offer may be calculated, by someone with ordinary skill in the art, using the following algorithm: For a specific social graph w, for every other social graph v, compute a similarity s between v and w based on, weighting for statistical significance, previously shown interest in offers o, previously shopped merchants m, previously visited types of merchants t, social network likes l, physical proximity of wallet users to merchant m as p, demographic information d and offers redeemed r, retain a configured number or percentage of top graphs, ranked by similarity and weighted, as a neighborhood n. Then for every offer o that some social graph in n has a preference for, but that w has no preference for yet, for every other social graph x in n that has a preference for o, compute a similarity s between w and x, using x's preference for o, weighted by s, include v's weighted preference into a running average. The running average of the weighted preference then indicates a social graph's likely preference for a specific merchant. In this embodiment, offers from merchants that a social graph is more likely to respond to are prioritized in their display or placement. In an embodiment, clusters of geographic proximity of users within social graphs may be used in computing neighborhoods or similarity between social graphs. In an alternate embodiment, social graphs may be segmented into groups based on proximity of users to merchants for determining the prioritization of those offers within the users of the social graph, so that a social wallet user in another country is not presented with a prioritized offer for a merchant that the user.

In an alternate embodiment, a Slope-one calculation is used to determine a wallet user's possible preferences for an offer. In this embodiment, a user of ordinary skill in the art would first perform a pre-calculation using the following algorithm. For every offer o, for every other offer p, for every user u expressing preference for both o and p, add the difference in u's preference for o and p to an average preference and store the average preference difference. Then to determine the likely relevance of an offer to a user u the following algorithm is used: For every offer o the user u expresses no preference for and every offer p that social wallet user u expresses a preference for, find the average preference difference between o and p add this difference to u's preference value for p, add this to a running average, return the top offers, ranked by these averages. In alternate embodiments, preferences for a merchant, preferences for a type of merchant or preferences for a type of offer may be calculated in place of the offers o and p. In another embodiment, the Slope-one calculation is used to determine likely social graph preferences instead of an individual user's likely preferences.

In another aspect, by someone of ordinary skill in the art of statistics, the results of different embodiments of neighborhood and preference calculations may be combined in ways that make the results more statistically relevant. In an alternate embodiment, the actual observed response to an offer or merchant is analyzed against the calculated preference data. This difference is then used to by the practitioner of ordinary skill to test results and change weightings to improve the accuracy of the algorithms or mix of algorithms used.

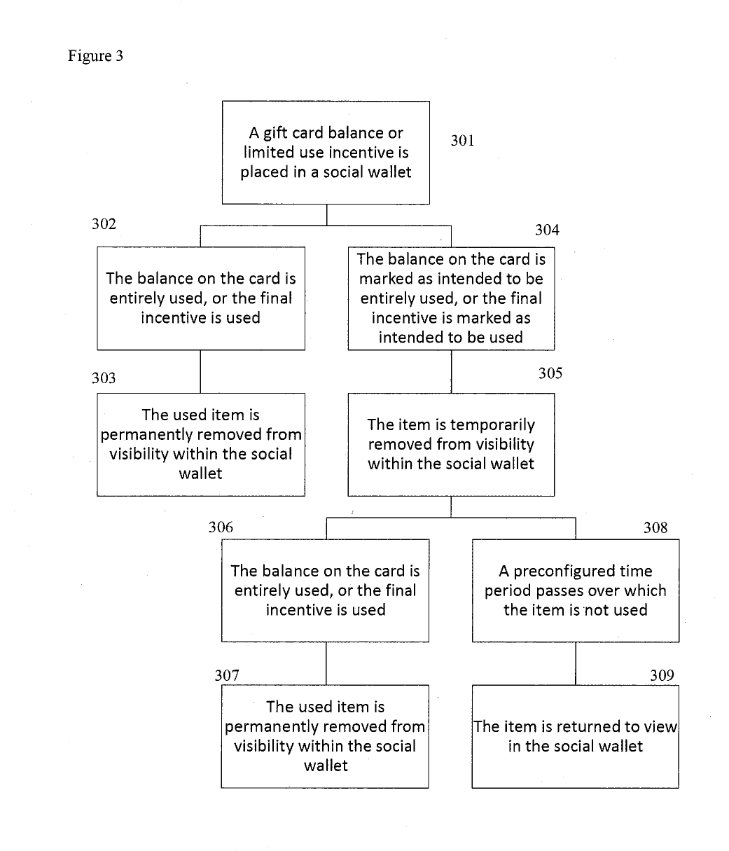

FIG. 3 is an exemplary flowchart depicting an embodiment transaction process of an intended use feature of a social wallet system. In an embodiment, an item is placed in a social wallet 301. If the value of the item is entirely used 302 by another user, then the used item is permanently removed from visibility within the social wallet 303. However, if a user marks an item as intended to be entirely used 304, then the item is temporarily removed from visibility within the social wallet 305. Thereafter, if the value of the item is entirely used 306, within a preconfigured time period, then the item is permanently removed from visibility within the social wallet 307. But, if that preconfigured time period passes and the item is not entirely used 308, then the item is automatically returned to view within the social wallet 309.

In another aspect, the value present in stored value cards is shared among members of a social graph. In this example, the item contributed to the social wallet is a monetary value, for example say a user receives a stored value card for a particular store, but there are no stores in the area or the user does not desire anything from that particular merchant or the user simply does not wish to use the stored value. Then the user can contribute or place the stored value into their social wallet so other members of their social graph are able to access and use the stored value placed into their social wallet. The user who contributed that value is then credited with placing that item with a certain stored value amount into their social wallet and is able to withdraw or use other items placed into the social wallet.

In an embodiment, the user may mark a specific incentive that they intend to redeem or they may just redeem the incentive at a participating merchant. In the case of a single use or limited use incentive, either action may restrict the availability of the incentive within the social wallet. Intent to use may be configured with a limited lifespan, after which, if not redeemed, the incentive is automatically returned to the social wallet. In a preferred embodiment, a user may be restricted as to the number of limited use incentives that she may intend to use, thus allowing other limited use incentives to remain available for others to use or express an intention to use.

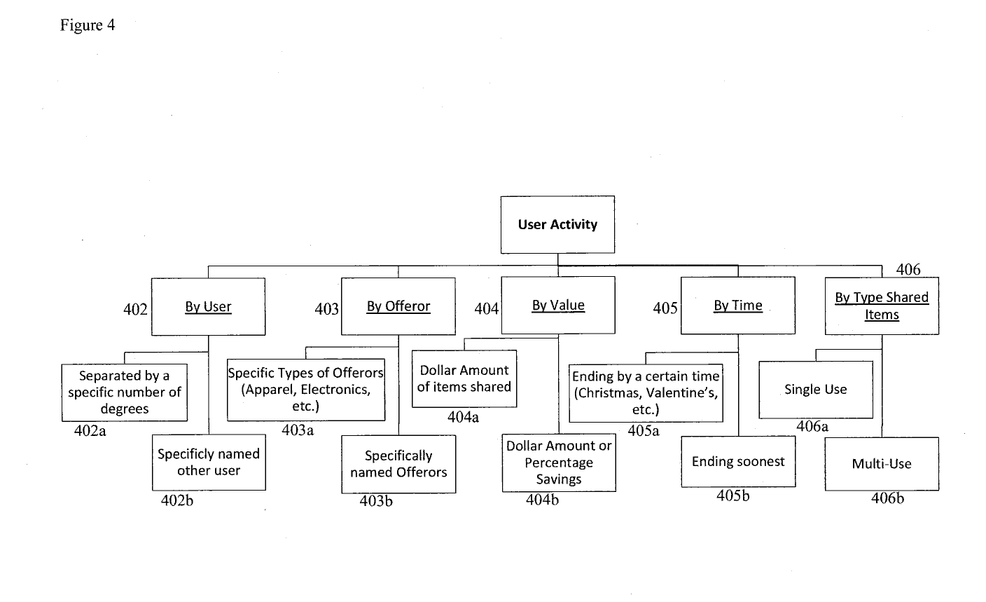

FIG. 4 is a block diagram of an embodiment of a basic system for describing the activities of a user 401 in a social wallet system. The activities of a user 401 in certain aspects are used as a means for users searching for other users, as a means for categorizing what types of other users for whom they allow access to their own items, as a means for categorizing what types of other users whose items they would like access to, and as an element in assisting offerors with whom they would like to target their items towards.

In an embodiment, there are several types and sub-types of user activities 401 which would be relevant in such a social wallet system, the following list is not intended to be exclusive or limiting in activities that are relevant to the social wallet system and method. Each criteria may be used individually or in combination with any or all others. One manner of describing activity is by the user 402. Relevant sub-types would include a specifically named user 402a, as well as all other related users separated from that user by a certain number of degrees 402b. The related users identified in 402b allow a method for describing a user 401 by the activities of the person who are related to that user 401 via their social graphs. For example, if the user 401 is linked both directly and indirectly to a number of other users who are involved or frequent sporting goods merchants that user 401 might be more receptive to offers for sporting goods merchants since their social graphs are populated with persons who have that common interest. In this manner describing a user 401 activities by the activities of persons that user 401 is connected to via their common social graphs, i.e. related users 402b, it is possible to more accurately target promotions and offer relevant offers.

Another type of describing activity depicted in FIG. 4 is by offeror 403. This type would classify users by activity they had with items based on the item's relationship to an offeror. Relevant sub-types would include not just specifically named offerors 403a, but also specific types of offerors 403b.

Another type of describing activity is by value 404. This type would classify users by activity they had based on the ranges of values of items they had activity with 404a, as well as the ranges of values of savings they had activity with 404b, either in terms of dollar amount savings or percentage savings. The value of the activity may be calculated based on the price of the item or times that can be purchased with an offer. An alternate aspect is calculating the value of user activity based on the actual amount of sales generated from use of the offer or offers shared. In an embodiment, the profitability of generated sales may be calculated to determine all or part of the value in 404 and 404a. In an embodiment, the value of the shared offers may be weighted based on if the redeemer is a new customer of the offeror or an existing customer. In this embodiment, the value of the new customer redemption to the merchant may be higher than an existing customer's redemption. In another aspect, the value of the activity may be used in calculating the statistical correlation coefficients for statistical neighborhoods or the likely preference of a user or wallet for an offer.

Another type of describing activity is by time 405. This type would classify users by activity they had with items based on their relative activities proximity leading up to specific calendar dates 405a, or based on recentness to the present 405b. Another type of describing activity is by the type of item. This type would classify users by what type of items they have had activity with 406. Sub-types would include items of the type of single-use 406a, multi-use 406b, multi-limited-use, or gift cards with stored values.

In another aspect, the various activity described in FIG. 4 may be assigned numerical values and programmatically summarized in calculations by someone of ordinary skill in the art. In an embodiment, these calculated values may be used to establish the influence of a social wallet user or the aggregate values of the described activity based on the user's social graph.

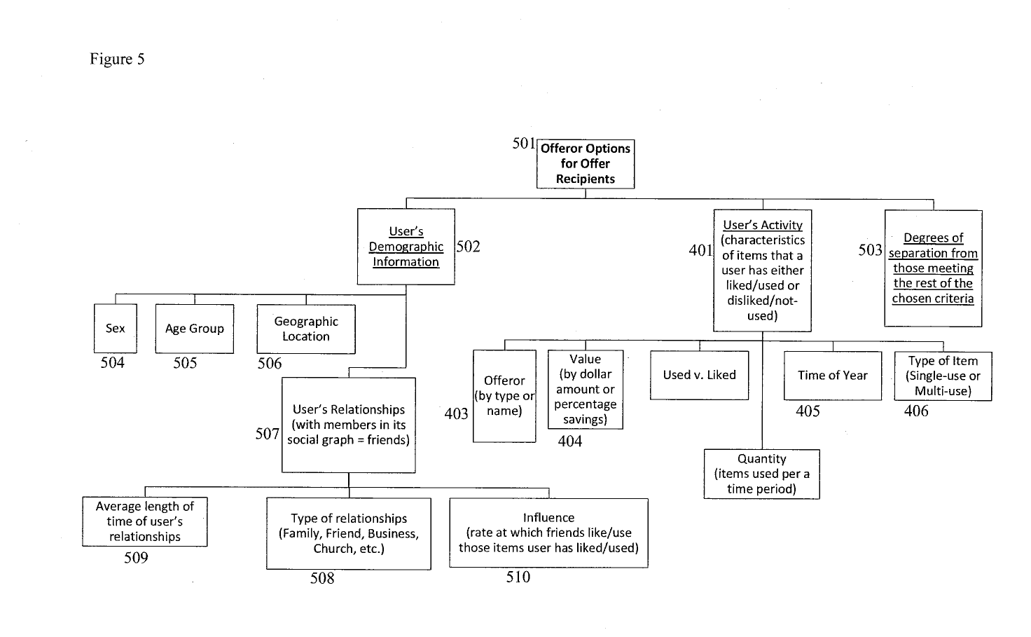

FIG. 5 is a block diagram of an embodiment of a system, available to an offeror, for choosing the characteristics of those users they make offers to 501. As explained previously, there are many benefits, to both user and offeror, of a system that more efficiently targets marketing promotions. Such efficiencies are realized by allowing an offeror to finely tailor the group of recipients which receive certain types of items. In a preferred embodiment offerors maintain marketing research that details what groups of people are using their products and in what concentrations, similarly an offeror might have access to data that suggests underperformance amongst a particular consumer group relative to their competition. With such data in hand, an offeror could present savings to groups of consumers that currently don't buy their product, but where data suggests they might.

In an embodiment, those options available to an offeror for whom they send offers to can include: the same options described in FIG. 4 that describe a user's activity 401; options related to specific demographic information about a user 502; and options for how many degrees of separation from an ideal user for which offers should also go out to 503. The options related to demographic information about a user 502 can include the sex 504, the age group 505, their geographic location 506, and their relationships with members in their social graph 507. As used herein, the term “friend” will refer to someone in a user's social graph. The options for relationships of a user that an offeror might also wish to extend an item to include: by types of relationship 508 (family, classmates, business, church); by average length of relationships 509; and by the influence 510 that user has over the other people they are friends with. A high level of influence can be characterized by a user who has a high rate at which their friends like or use those items the user has liked or used.

With respect to geographic location 506, there are multiple aspects that are capable or in some aspects useful for tracking. In one aspect the user's nominal locations such as home or work are tracked in order to provide offers that are in close proximity to those locations where the user is commonly present. In another aspect, the geographic location 506, utilizes geolocation services in a mobile device or similar product to determine when a user is in proximity to a merchant offering a particular offer with a geographic sensitivity and when the user enters the vicinity of that location the item is offered to the user for use.

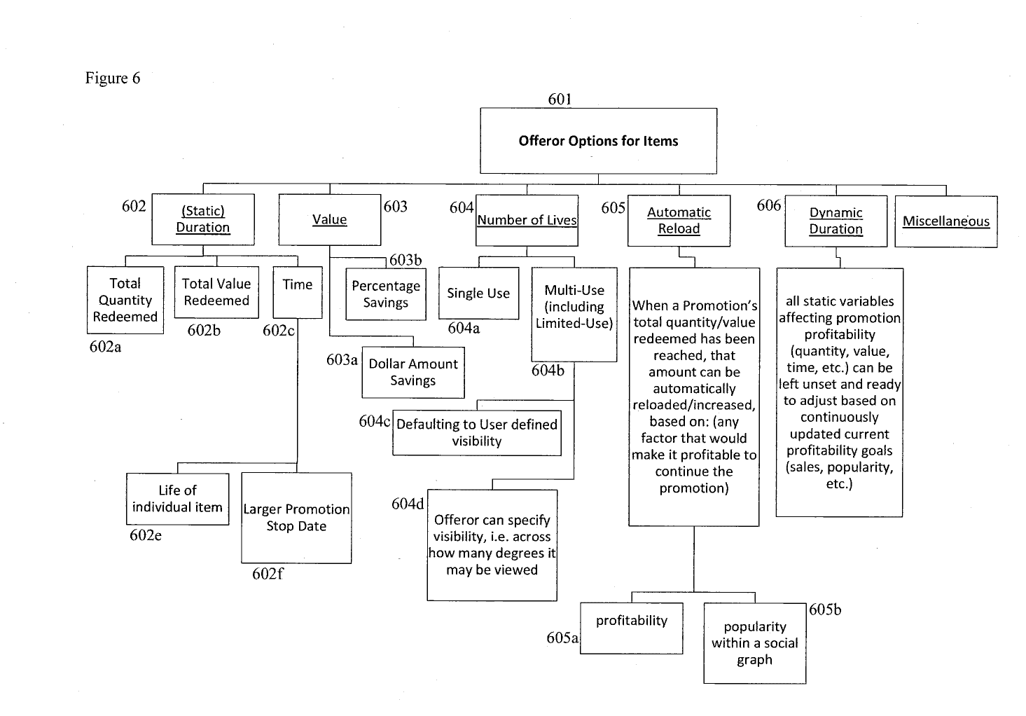

FIG. 6 is a block diagram of an embodiment of a basic system, available to an offeror, for choosing the details of the offers made to users 601. In a preferred embodiment, there are a number of options relevant to an offeror regarding the items they offer. An item option regarding the duration 602 of a particular item promotion can be limited by: the total quantity of items redeemed 602a; the total value of items redeemed 602b; or as a function of time 602c. Basing an item option duration on time can happen in at least two ways: by a promotion stop date or length of time 602d; or time periods of validity for individual items within a promotion 602e. An item option regarding the value 603 of individual items can be based on at least a dollar amount savings 603a or a percentage savings 603b. An item option regarding the number of lives 604 of a particular item can be based on an item being either a single-use 604a item or a multi-use 604b item. But multi-use 604b items can vary in important ways also, they can be used more than once, but they also might be restricted to a limited number of uses, as opposed to unlimited uses where the promotion would end based on some other condition. In an embodiment an item option regarding visibility of items across social graphs can be set by default to allow users to decide across how many degrees of separation they will allow friends to view and share their items 604c; or an offeror can specify the visibility of a given item 604d. Offerors who focus an item promotion towards a finely tailored group might wish to restrict redemption to friends too distant from the offeror's target group.

Users may be targeted based on similarity, such that an offer may be targeted to select users within a social graph who are not currently customers of a merchant, but share a similarity that indicates they are more likely to shop the same merchant. In this instance, the similarity has been established through the previously specified correlation and targeting mechanisms. These systems will prioritize the display of these shared offers more prominently or more often for these users identified as being more likely to become new customers of the merchant.

The prioritization and/or targeting of offers may be triggered by the physical location of the user or users, either based on the proximity to a merchant's location or based on the physical location of a user or users. As an example, a number of users may have a physical proximity near or at a specific concert or sporting event. The system may identify in a group these users and based on the established characteristics of these users or the assumption that they are attending a specific type of event, target shared offers from a merchant or merchants based on these characteristics or location. In this example, a shared offer for a wine bar may be targeted or prioritized for certain users who appear to be attending a Yo Yo Ma concert so that they may receive an after concert special offer.

The system may reward users whose friends in the social graph redeem rewards that the user has shared. Such that, if a user A shares an offer for an ice cream shop, and five of their friends redeem the offer, the user may received a special offer or reward. The offer may be a free item, a discount or a spendable credit onto their loyalty card or gift card account.

In another embodiment, an item option is available for automatic reload 605 of a promotion of items with a static duration, whether it be for the reloading of the total quantity of items, the total value of all savings from items, or by an extension of time. An offeror can configure such a system such that when an element of a promotion's total duration is going to be depleted, the system can be automatically reloaded to an amount based on some factor chosen predetermined by the offeror. Factors that an offeror would likely base such a reloading on include: a minimum level of profitability 605a of the overall promotion, or some measured amount of popularity 605b the promotion has reached within a social graph.

In another aspect the value of an item is adjusted based on the number of members in the social network who take advantage of a given offer. For example, in one aspect the merchant is able to trigger the value of an item to spur rebroadcasting within a social network. In one aspect the merchant may phase or trigger the value of the item to change based on the number of users in a social network who take advantage of the offer within a specific window. If the number exceeds the set amount, a higher value is available.

In an alternative embodiment, an item option is available for dynamically setting the duration of a promotion 606. Under such a dynamic duration 606 option, all static duration variables affecting promotion profitability (such as quantity 602a, value 602b, time 602c, etc.) can be left unset and ready to adjust based on continuously updated current profitability goals, such as sales and popularity. If the profitability goals are trending up, then the static duration variables can be increased. If the profitability goals are trending down, then the static duration variables can be decreased. For example, if an offeror is worried that a promotion could become too popular amongst its customers that usually pay full price, the dynamic duration option could be set based on a maximum percent of total sales dollars that are being discounted. As the amount of money being saved per the amount being taken in incrementally approaches that maximum value, the quantity of items offered each week could be incrementally reduced by a similar factor. That similar factor would be the proportion of how close to whatever maximum value you are, and by what proportion you reduce the amount of newly available items by. Such that the sales figures suggest that the maximum percent of total sales dollars that are being discounted is three quarters of the way reached, then the amount of items offered each week would be reduced by that same three quarters.

### CONCLUSION

While various embodiments of the present system and method have been described above, it should be understood that the embodiments have been presented by the way of example only, and not limitation. It will be understood by those skilled in the art that various changes in form and details may be made therein without departing from the spirit and scope of the invention as defined. Thus, the breadth and scope of the present invention should not be limited by any of the above described exemplary embodiments.

What is claimed is:

1. A method for the provision of sharing items among people, comprising:
receiving item information for a first item and a second item, wherein said first item and said second item are each retail incentives and are each associated with at least one user, wherein each of said at least one users has a relationship with a user friend;
determining a display priority between said first item and said second item, wherein said display priority is determined at least in part on said relationship between said at least one user and said user friend; and
displaying said item information in a location, wherein said location is viewable by said user friend, and said item information associated with said first item is displayed more prominently than said item information associated with said second item.

2. The method of claim 1 wherein determining said display priority further comprises:
comparing a first set of item characteristics to a set of user characteristics, wherein said first set of item characteristics is associated with said first item, wherein said user characteristics are associated with said user friend;
comparing a second set of item characteristics to said set of user characteristics, wherein said second set of item characteristics is associated with said second item;
identifying that said first set of item characteristics share more commonalities with said set of user characteristics than said second set of item characteristics share with said set of user characteristics; and
ranking said first item with a higher display priority than said second item.

3. The method of claim 1 wherein said item information associated with said first item is displayed more prominently than said item information associated with said second item by a form of relative visual emphasis selected from the group consisting of: vertical placement, horizontal placement, font type, font size, font color, background color, font sharpness, animation, outlining, and proximity to an icon.

4. The method of claim 1 further comprising:
rewarding said at least one user for the usage of an item by said user friend.

5. The method of claim 2 wherein at least one of said sets of item characteristics and said set of user characteristics contain at least one characteristic related to a geographic location.

6. The method of claim 2 wherein at least one of said sets of item characteristics and said set of user characteristics contain at least one characteristic related to a history of past consumer transactions.

7. The method of claim 2 wherein at least one of said sets of item characteristics and said set of user characteristics contain at least one characteristic based on factors comprising: a user's demographic information, information regarding their relationships with other users, and a user's sharing activity.

8. A computer readable storage medium having data stored therein representing software executable by a computer, the software including instructions to provide for the allocation of items among a network of people, the storage medium comprising:
instructions for receiving item information for a first item and a second item, wherein said first item and said second item are each retail incentives and are each associated with at least one user, wherein each of said at least one users has a relationship with a user friend;
instructions for determining a display priority between said first item and said second item, wherein said display priority is determined at least in part on said relationship between said at least one user and said user friend; and
instructions for displaying said item information in a location, wherein said location is viewable by said user friend, and said item information associated with said first item is displayed more prominently than said item information associated with said second item.

9. The computer readable storage medium of claim 8, further comprising:
instructions for comparing a first set of item characteristics to a set of user characteristics, wherein said first set of item characteristics is associated with said first item, wherein said user characteristics are associated with said user friend;
instructions for comparing a second set of item characteristics to said set of user characteristics, wherein said second set of item characteristics is associated with said second item;
instructions for identifying that said first set of item characteristics share more commonalities with said set of user characteristics than said second set of item characteristics share with said set of user characteristics; and
instructions for ranking said first item with a higher display priority than said second item.

10. The computer readable storage medium of claim 8 wherein said item information associated with said first item is displayed more prominently than said item information associated with said second item by a form of relative visual emphasis selected from the group consisting of: vertical placement, horizontal placement, font type, font size, font color, background color, font sharpness, animation, outlining, and proximity to an icon.

11. The computer readable storage medium of claim 9 wherein at least one of said sets of item characteristics and said set of user characteristics contain at least one characteristic related to a geographic location.

12. The computer readable storage medium of claim 9 wherein at least one of said sets of item characteristics and said set of user characteristics contain at least one characteristic related to a history of past consumer transactions.

13. The computer readable storage medium of claim 9 wherein at least one of said sets of item characteristics and said set of user characteristics contain at least one characteristic based on factors comprising: a user's demographic information, information regarding their relationships with other users, and a user's sharing activity.

14. A method for tailoring promotions to specific people, comprising:
identifying a plurality of characteristics associated with a class of consumers for whom an item should be directed, wherein said item is a retail incentive;
accessing a database which contains a plurality of characteristics associated with a plurality of users in a sharing network;
matching said plurality of characteristics associated with said class of consumers with a plurality of characteristics from said database;
inputting into said database at least one matching characteristic shared between said plurality of characteristics of said class of consumers and said plurality of characteristics associated with said plurality of users in said sharing network from said database;
receiving from said database a list of users from within said sharing network that correlate to said class of consumers;
offering said item to said list of users by displaying item information for said item in a location, wherein said item information is displayed more prominently than item information associated with a second item.

15. The method of claim 14, wherein said item offered has a series of options that describe its terms comprising: the item's duration, the value of the item, the number of uses of the item, and conditions under which the other options automatically reload.

16. The method of claim 15, wherein said option describing the item's duration is static in that the item is no longer valid after: a predetermined quantity of items have been redeemed, a predetermined total value of all items in a particular promotion that have been redeemed, or after a predetermined amount of time has elapsed.

17. The method of claim 15, wherein said option describing the item's duration is dynamic in that all static variables affecting promotion profitability can be left unset and ready to adjust based on at least one current profitability goal.

18. The method of claim 16, wherein said conditions under which the other options automatically reload is based on an offeror's reload factor, wherein said reload factor can be set to increase an element of a promotion's total duration before it is depleted based on a predefined minimum level of profitability of an overall promotion or a predefined amount of popularity said promotion has reached within a particular network.

19. The method of claim 14, wherein said plurality of characteristics associated with a plurality of users in a sharing network include: a user's demographic information, information regarding their relationships with other users, and a user's sharing activity.

20. The method of claim 18, wherein the information regarding a user's relationships with other users describes a number of degrees of separation between the user and other users in the network by restricting out those other users who match the other characteristics but are not connected to said user within said number of unique friends.
